(19) United States
(12) Patent Application Publication
(10) Pub. No.: US 2009/0100061 A1
(43) Pub. Date: Apr. 16, 2009

(54) Information processing apparatus and information processing method

(75) Inventor: Eiichiro Yoshida, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/285,450

(22) Filed: Oct. 6, 2008

(30) Foreign Application Priority Data
Oct. 11, 2007 (JP) 2007-265643

(51) Int. Cl. G06F 12/14; G06F 17/30

(52) U.S. Cl. 707/9; 707/E17.005

(57) ABSTRACT

An information processing apparatus and an information processing method capable of effectively performing access control with respect to items of information are disclosed. The information processing apparatus determining whether an operation with respect to information including plural items is permitted includes a classified information managing unit managing classified information in which categorization of the plural items is defined, an operation authority information managing unit managing operation authority information in which an operating authority given to an operation subject is set with respect to each of the categories, a category determining unit determining a category that is to include an item to be operated based on the classified information, and a permit determining unit determining whether an operation is permitted based on the category determined by the category determining unit and the operation authority information.

### CROSS-REFERENCE TO RELATED APPLICATIONS

The present application claims priority under 35 U.S.C §119 to Japanese Patent Application No. 2007-265643 filed Oct. 11, 2007, the entire contents of which are hereby incorporated herein by reference.

### BACKGROUND OF THE INVENTION

1. Field of the Invention

The present invention generally relates to an information processing apparatus and an information processing method, and more specifically to an information processing apparatus and an information processing method capable of determining whether an operation with respect to information including plural items is permitted.

2. Description of the Related Art

Conventionally and traditionally, the access control has been implemented based on access control information such as Access Control List (ACL) with respect to information managed in a computer system such as a document management system. In this case, the ACL is provided for each of the resources of the system; and the access authority may be separately set with respect to each of the resources for each user. In this case, the access control is based on each of the resources. As a result, when a referring authority is set with respect to a document “L” for a user “X”, the user “X” may refer to all the attribute information of the document “L”.

Further, to realize more sophisticated access control, a system has been provided in which access authority may be separately set for each item (field) of the attribute information. In this system, an access authority may be set so that, for example, the document name of the document “M” may be referred to; however, the data of the document “M” may not be referred to.

Patent Document 1: Japanese Patent Application Publication No. 2005-038371.

However, unfortunately, when an access authority may be separately set for each field, the more the number of fields increases, the more cumbersome and complicated become operations necessary for completing the access authorities. Further, disadvantageously, due to the increasing amount of the access control information, more and more capacity is required for storing the access control information in a storage device.

### SUMMARY OF THE INVENTION

The present invention is made in light of the above circumstances, and may provide an information processing apparatus and an information processing method capable of effectively performing access control with respect to the items included in information.

To that end, according to an aspect of the present invention, there is provided an information processing apparatus capable of determining whether an operation with respect to information including plural items is permitted. The apparatus includes a classified information managing unit managing classified information in which categorization of the items is defined, an operation authority information managing unit managing operation authority information in which an operating authority given to an operation subject is set with respect to each of the categories, a category determining unit determining a category based on the classified information, the category including an item to be operated, and a permit determining unit determining whether an operation is permitted based on a category determined by the category determining unit and the operation authority information.

In such an information processing apparatus, it becomes possible to effectively perform access control with respect to the items included in information.

Advantageously, according to an embodiment of the present invention, there are provided an information processing apparatus and an information processing method capable of effectively performing access control with respect to the items included in information.

### BRIEF DESCRIPTION OF THE DRAWINGS

Other objects, features, and advantages of the present invention will become more apparent from the following description when read in conjunction with the accompanying drawings, in which:

FIG. 1 is a schematic drawing illustrating an exemplary configuration for managing information in an image processing apparatus according to an embodiment of the present invention;

FIG. 2 is a block diagram showing an exemplary hardware configuration of an image forming apparatus according to an embodiment of the present invention;

FIG. 3 is a block diagram showing an exemplary software configuration of an image forming apparatus according to a first embodiment of the present invention;

FIG. 4 is a drawing showing an example of an access control list (ACL) with respect to data of one document;

FIG. 5 is a drawing showing an example of an attribute category table;

FIG. 6 is a drawing showing an example of an authority definition table;

FIG. 7 is a drawing showing an example of an authority set definition table;

FIG. 8 is a drawing showing relationships between key software components in the first embodiment of the present invention;

FIG. 9 is a sequence diagram showing a process of operating a field according to the first embodiment of the present invention;

FIG. 10 is a sequence diagram showing a process of operating a field according to a second embodiment of the present invention;

FIG. 11 is a sequence diagram showing a process of operating a field when the field is not classified in any attribute category;

FIG. 12 is a drawing showing relationships between key software components in a third embodiment of the present invention;

FIG. 13 is a sequence diagram showing a process of operating a field according to the third embodiment of the present invention;

FIG. 14 is a drawing showing a relationship between the attribute category and the field according to a fourth embodiment of the present invention;

FIG. 15 is a drawing showing an example of an authority definition table according to the fourth embodiment of the present invention;

FIG. 16 is a drawing showing an example of the authority set definition table according to the fourth embodiment of the present invention;

FIG. 17 is a drawing showing a relationship between the attribute category and the field according to a fifth embodiment of the present invention;

FIG. 18 is a drawing showing an example of the attribute category table according to the fifth embodiment of the present invention;

FIG. 19 is a drawing showing an example of the authority definition table according to the fifth embodiment of the present invention; and

FIG. 20 is a drawing showing an example of the authority set definition table according to the fifth embodiment of the present invention.

### DETAILED DESCRIPTION OF THE PREFERRED EMBODIMENTS

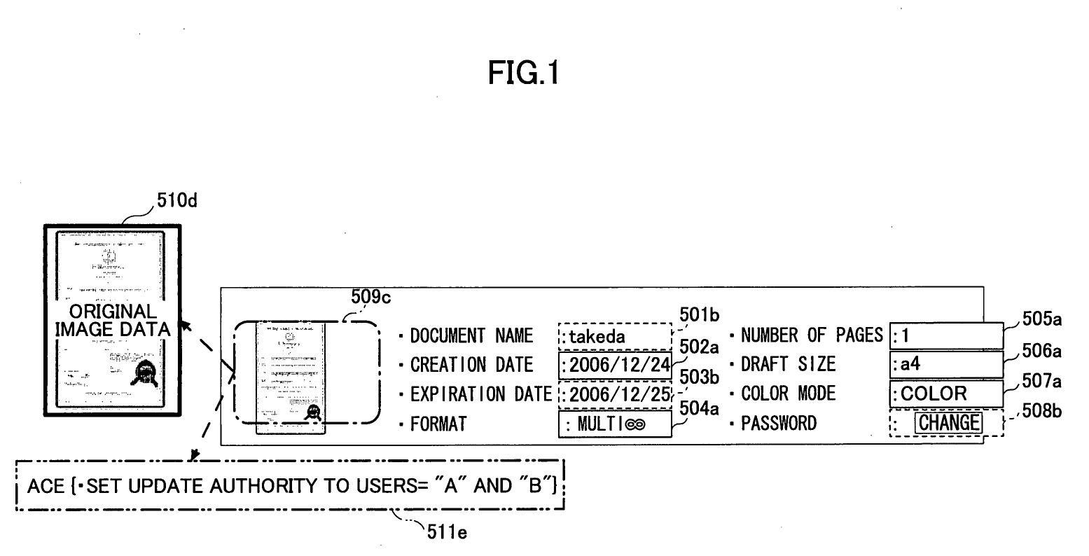

In the following, embodiments of the present invention are described with reference to the accompanying drawings. FIG. 1 schematically and exemplarily shows how information is managed in an information processing apparatus according to an embodiment of the present invention. FIG. 1 shows a case where document data (document information) is being managed. As shown in FIG. 1, the data (record) of one document includes plural fields (attribute items) such as a document name 501b, a creation date 502a, an expiration date 503b, a format 504a, a number of pages 505a , a draft size 506a, a color mode 507a, a password 508b, a thumbnail image 509c, original image data 510d, and Access Control Entry (ACE) 511e.

In the embodiments of the present invention, the plural fields are divided into some groups (hereinafter referred to as “attribute categories”), so that the fields in the same group are similarly treated in an access control process; and an access authority (operating authority) may be separately set for each attribute category. As shown in FIG. 1, the fields (attribute items) in the same attribute category have the same suffix (“a” through “e”) attached to the reference numeral. Namely, in this case, a field having a suffix “a” attached to its reference numeral is classified as an attribute category called “property (PR)”. In the same manner, fields having suffixes “b”, “c”, “d”, and “e” attached to their reference numerals are classified as attribute categories called “annotation (AN)”, “thumbnail image (TI)”, “image (IG)”, and “ACE (AC)”, respectively.

Advantageously, by classifying the fields (attribute items) into plural groups (attribute categories) as described above, and by making it possible to set an access authority for each group (attribute category), it may become possible to facilitate and simplify a setting process of setting the access authorities and reduce the memory capacity necessary to store the information of the access authorities.

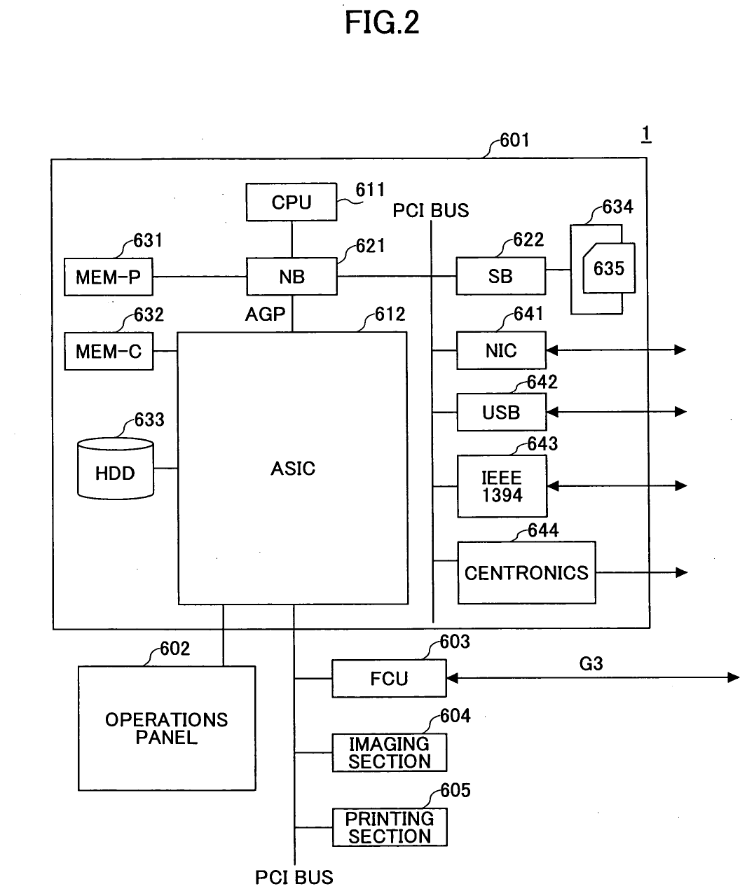

In the following, an image forming apparatus is described as a specific example of the information processing apparatus according to an embodiment of the present invention. FIG. 2 shows an example of a hardware configuration of an image forming apparatus according to an embodiment of the present invention. In FIG. 2, as a specific example of the image forming apparatus, a multi-functional peripheral 1 is shown. It should be noted that the multi-functional peripheral 1 may include plural functions such as a printer, a copier, a scanner, or a facsimile machine in the single chassis of the multi-functional peripheral 1.

As shown in FIG. 2, the hardware of the multi-functional peripheral 1 includes a controller 601, an operations panel 602, a facsimile control unit (FCU) 603, an imaging section 604, and a printing section 605.

The controller 601 includes a CPU 611, an ASIC 612, an NB 621, an SB 622, an MEM-P 631, an MEM-C 632, a hard disk drive (HDD) 633, a memory card slot 634, a network interface controller (NIC) 641, a USB device 642, an IEEE 1394 device 643, and a Centronics device 644.

The CPU 611 is an IC for processing various information items. The ASIC 612 is an IC for performing various image processing. The NB 621 is the north bridge of the controller 601. The SB 622 is the south bridge of the controller 601. The MEM-P 631 is a system memory of the multi-functional peripheral 1. The MEM-C 632 is a local memory of the multi-functional peripheral 1. The HDD 633 is a storage device in the multi-functional peripheral 1. The memory card slot 634 receives a memory card 635. The NIC 641 is a controller for network communications using the MAC address of the NIC 641. The USB device 642 provides a USB standard connecting terminal. The IEEE 1394 device 643 provides an IEEE 1394 standard connecting terminal. The Centronics device 644 provides a Centronics standard connecting terminal. The operations panel 602 is hardware (an operating section) through which an operator enters and transmits information to the multi-functional peripheral 1 and is also hardware (a display section) through which an operator acquires information from the multi-functional peripheral 1. The imaging section 604 is hardware (a scanner) for reading an image (image data) from a draft sheet. The printing section 605 is hardware (a printer) for printing an image (image data) onto a printing sheet.

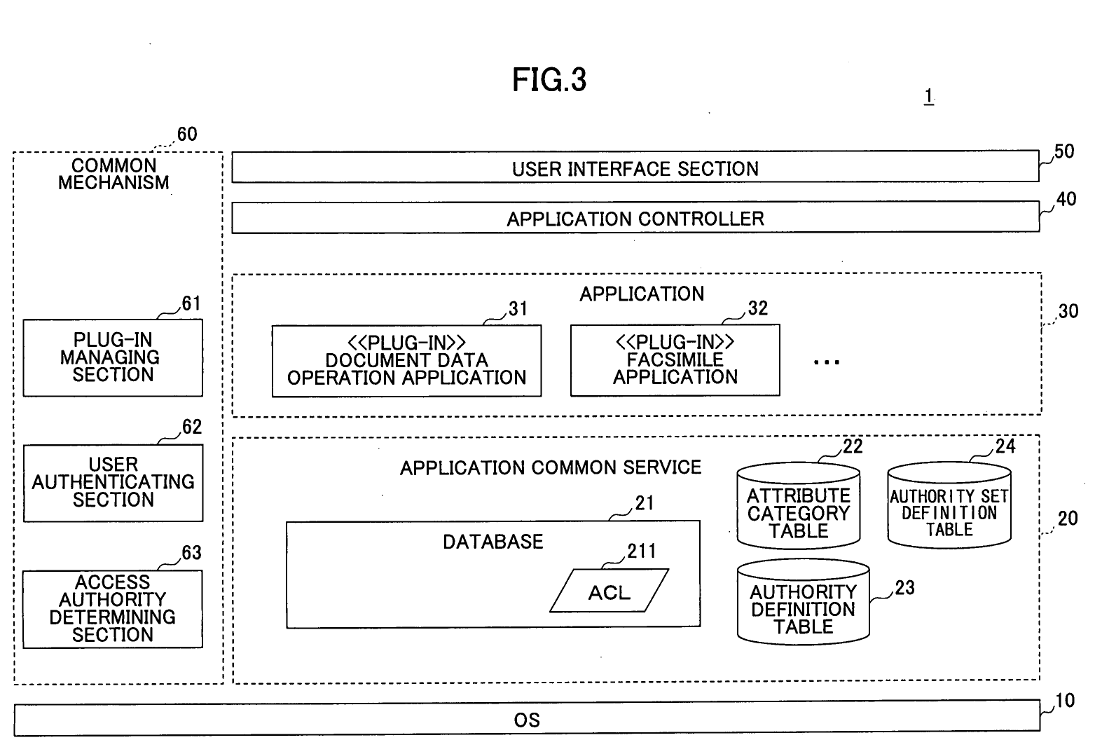

FIG. 3 shows an exemplary software configuration of an image forming apparatus according to a first embodiment of the present invention. As shown in FIG. 3, the software of the multi-functional peripheral 1 may include an OS 10, an application common service 20, an application 30, an application controller 40, a user interface section 50, and a common mechanism 60.

The OS 10 may be a general-purpose OS. The application common service 20 includes a software component providing a common service to each application in the application 30. In an example of FIG. 3, the application common service 20 includes a database 21, an attribute category table 22, an authority definition table 23, and an authority set definition table 24.

The database 21 manages the data of a document (document data) and the like in the first embodiment of the present invention. Further, an access control list (ACL) 211 for each document data is registered in the database 21.

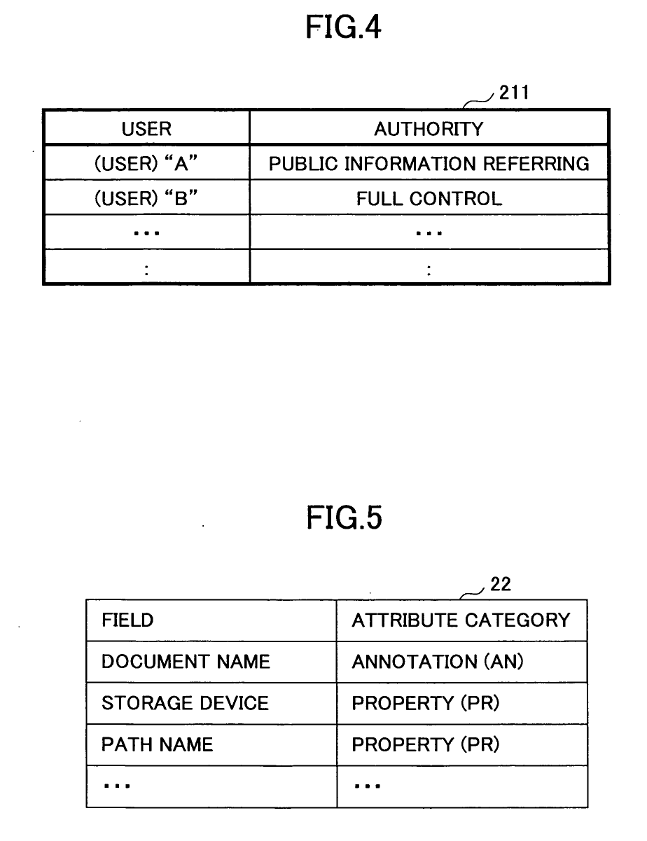

FIG. 4 shows a sample of the ACL 211 defined with respect to the document data. As shown in FIG. 4, an authority (operating authority) is separately set for each user. More specifically, with respect to the (associated) document data, a “public information referring” authority is set for the user “A”, and a “full control” authority is set for the user “B”. In this manner, the ACL 211 includes data in which a separate operating authority is set for each user (operating subject) with respect to the corresponding document data and may be stored in the HDD 633 or the like. It should be noted that each of the terms “public information referring” and “full control” is defined as an authorization set in an authority set definition table 24 described below.

FIG. 5 shows an example of an attribute category table 22. As shown in FIG. 5, the relationships between fields of the document data and the corresponding attribute categories are registered in the attribute category table 22; namely each field is classified in the corresponding attribute category. The attribute category table 22 may be stored in the HDD 633 or the like. In the example of FIG.5, a “document name” field belongs to (or, is included in) an “annotation (AN)” attribute category; and each of a “storage device” field and a “path name” field belongs to (or, is included in) a “property (PR)” attribute category.

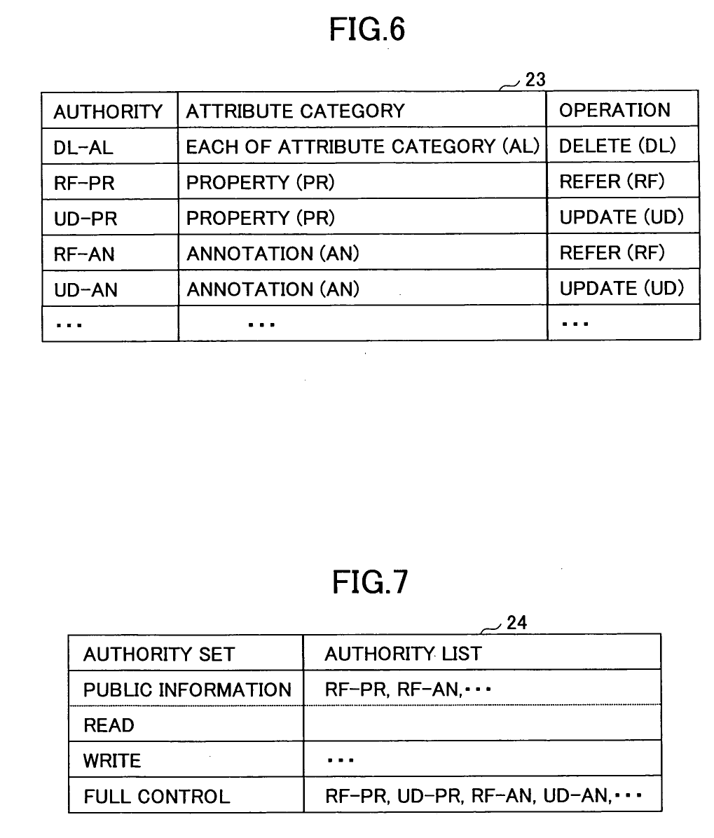

FIG. 6 shows an example of an authority definition table 23. As shown in FIG. 6, each (authority) indicating an authorized operation with respect to the corresponding attribute category is registered in the authority definition table 23. The authority definition table 23 may be stored in the HDD 633 or the like. In the example of FIG. 6, the authority that permits a “delete (DL)” operation with respect to each of the attribute categories is registered as “DL-AL”. Further, the authorization that permits a “refer (RF)” operation with respect to a “property (PR)” attribute category is registered as “RF-PR”, and the authorization that permits an “update (UD)” operation with respect to the “property (PR)” attribute category is registered as “UD-PR”. Further, the authorization that permits a “refer (RF)” operation with respect to an “annotation (AN)” attribute category is registered as “RF-AN”, and the authorization that permits an “update (UD)” operation with respect to the “annotation (AN)” attribute category is registered as “UD-AN”.

FIG. 7 shows an example of an authority set definition table 24. As shown in FIG. 7, in the authority set definition table 24, each (authority set) in the “authority” column (see FIG. 4) in the ACL 211 is defined as a list of “authority” (see FIG. 6) in the authority definition table 23. The authority set definition table 24 may be stored in the HDD 633 or the like. For example, as shown in FIG. 7, the authority set called “public information” includes authorities called “RF-PR” and “RF-AN” (see FIG. 6). Advantageously, by registering a combination (pattern) of authorities as the authority set in the ACL 211 in advance, it becomes possible to simplify the setting process in the ACL 211.

The application 30 includes an application that can be directly operated by a user through the operations panel 602. In the example of FIG. 3, the application 30 includes a document data operation application 31 and a facsimile application 32. It is assumed that an application may be added as a plug-in module.

The application controller 40 interprets the information entered through the operations panel 602 and controls the application 30 in response to the entered information.

The user interface section 50 displays various operation screens on the operational panel 602 and transmits the information entered through the operation screen to the application controller 40.

The common mechanism 60 includes a software component commonly used from outside of the common mechanism 60. In the example of FIG. 3, the common mechanism 60 includes a plug-in managing section 61, a user authenticating section 62, and an access authority determining section 63.

The plug-in managing section 61 manages the information of an application added as a plug-in. The user authenticating section 62 performs a user authentication process when a user logs in and identifies a user who is currently performing an operation. The access authority determining section 63 determines whether an access (operation) with respect to each resource in the multi-functional peripheral 1 is permitted. It should be noted that the term “resource” includes each of the fields of the document data.

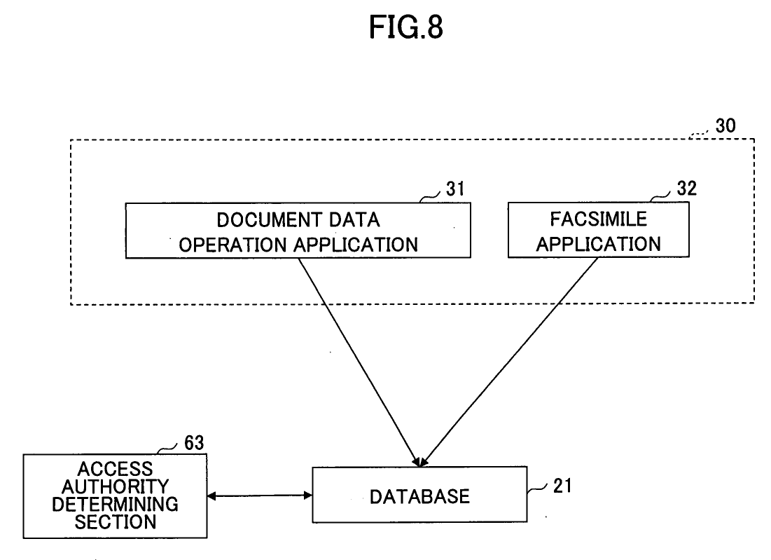

Among the software components illustrated in FIG. 3, the operations of the application 30, the database 21, and the access authority determining section 63 are described in more detail in the descriptions of the embodiments of the present invention. FIG. 8 shows relationships among the key software components in a first embodiment of the present invention.

In the relationships shown in FIG. 8, the application 30 (including the document data operation application 31 and the facsimile application 32) operates a field of the document data in accordance with a request from a user, the document data being managed in the database 21. In this case, the database 21 transmits a request to the access authority determining section 63 to determine whether the operation with respect to the field by the user is permitted. When it is determined that the operation is permitted, the operation with respect to the field is carried out.

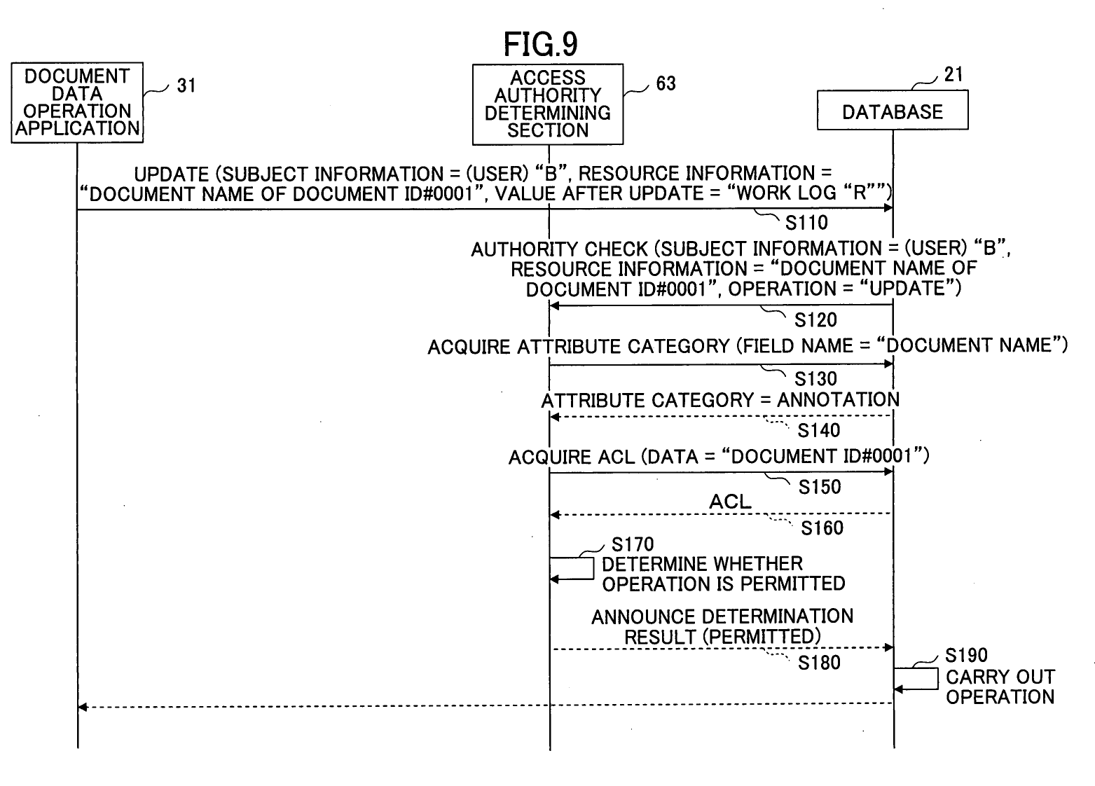

In the following, a process executed based on the relationships shown in FIG. 8 is described. FIG. 9 is a sequence diagram showing a process when a field is operated according to the first embodiment of the present invention.

For example, based on an instruction input by a user, the document data operation application 31 transmits a request to the database 21 to operate a field of document data (step S110). The operation request designates a type of operation identification information of the subject in the operation (subject information), identification information of the resource (field) to be operated (resource information), and the like. In the case of FIG. 9, the type of operation is “update (UD)”, the subject information is “(user) “B””, and the resource information is “document name of document ID#0001”. It should be noted that when the type of operation is “update (UD)”, a value after update (in this case, “work log R”) is also designated. Namely, the operation requested in step S110 corresponds to the “(user) “B”” updating the document name of the document data of document ID#0001 to “work log “R””.

Upon receiving the request, the database 21 transmits a request to the access authority determining section 63 along with data of the subject information (user “B”), the resource information (document name of document ID#0001), and the type of operation (update (UD)) (step S120). The access authority determining section 63 inquires the database 21 about the attribute category including the field to be operated (document name) designated in resource information (step S130). The database 21 determines the attribute category including the field based on the attribute category table 22 (see FIG. 5) and transmits the determined attribute category (annotation (AN)) to the access authority determining section 63 (step S140). In the above process, the target operation to be checked is whether “the user “B” can update the annotation (AN)” from an authority point of view.

Next, the access authority determining section 63 acquires the ACL 211 (see FIG. 4) of the document data whose document ID is “0001” from the database 21 (steps S150 and S160). Based on the acquired ACL 211, the access authority determining section 63 acquires the authority data (in this case, “full control”) corresponding to the user “B”, and further acquires authority list data (in this case, “RF-PR, UD-PR, RF-AN, UD-AN, . . . ”) corresponding to the “full control” in the authority set column in the authority set definition table 24 (see FIG. 7). The access authority determining section 63 determines whether the operation (to update the annotation (AN)=“UD-AN”) is included in the acquired authority list data (RF-PR, UD-PR, RF-AN, UD-AN, . . . ) to determine whether the operation is permitted (step S170). In this case, the operation of “UD-AN” is included in the acquired authority list, therefore the operation is permitted. On the other hand, when a requested operation is not included in the acquired authority list, the operation is not permitted.

Next, the access authority determining section 63 transmits the determination result whether the requested operation is permitted to the database 21 (step S180). When the requested operation is permitted in the determination result, the database 21 carries out a necessary process to perform the requested operation (step S190).

Next, a second embodiment of the present invention is described. In the following, the parts differing between the second embodiment and the first embodiment are described. Therefore, it may be assumed that the parts that are not described below are the same as those in the first embodiment.

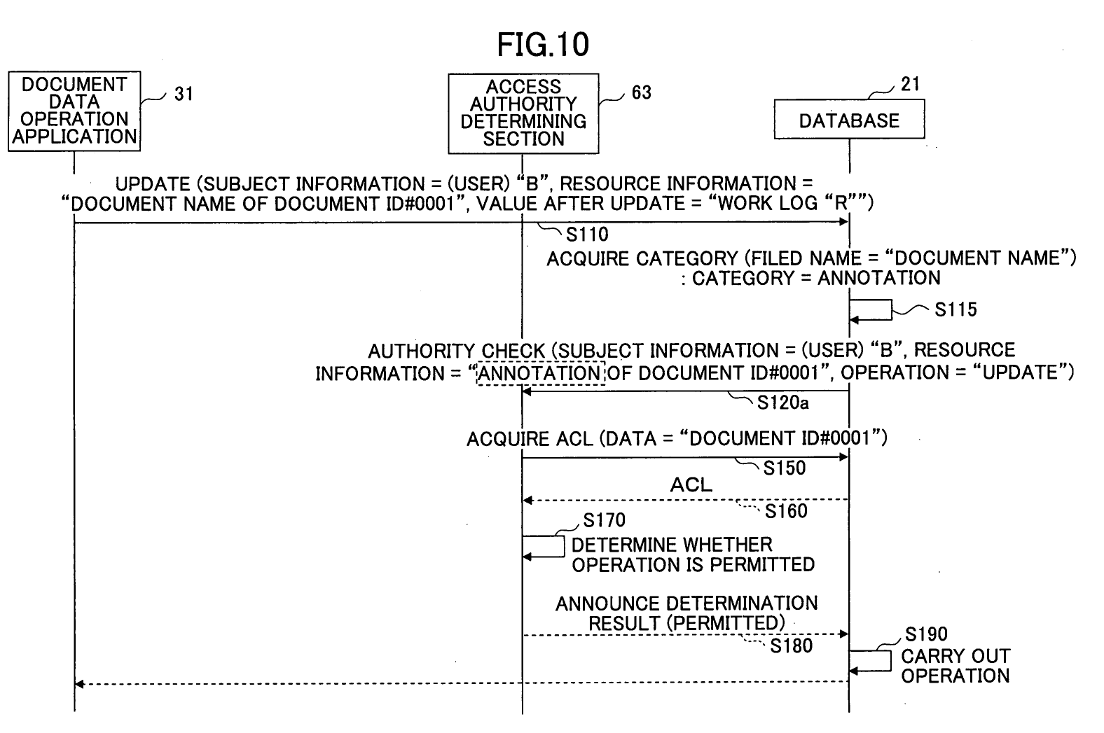

FIG. 10 is a sequence diagram showing a process of operating a field according to the second embodiment of the present invention. In FIG. 10, the same step numbers are used for the same operations.

As shown in FIG. 10, upon receiving an operation request (step S110), the database 21 converts the field name (document name) into the corresponding attribute category name (annotation (AN)) based on the attribute category table 22 (step S115). Then, the database 21 designates the attribute category (annotation (AN)) as the resource information and transmits a request to check the authority (step S120a). Therefore, the access authority determining section 63 performs the processes from step S150 without inquiring about the attribute category including the field to be operated.

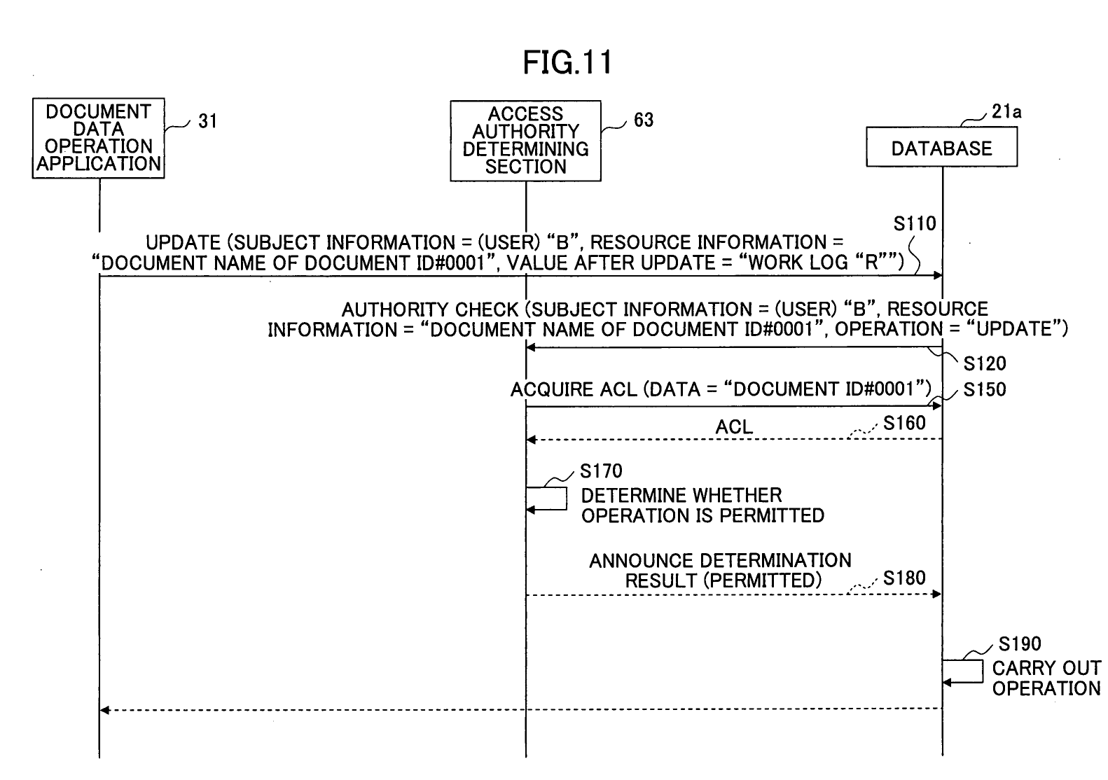

According to the process in FIG. 10, the access authority determining section 63 does not have to be concerned about the conversion from a field name to an attribute category name. As a result, even upon receiving an inquiry from a database in which each field of the information to be managed is not classified into an attribute category, the access authority determining section 63 may determine whether the operation is permitted in the same manner as in a case where the access authority determining section 63 receives an inquiry from a database in which each field is classified into the corresponding attribute category. This feature is described in more detail below with reference to the sequence diagram in FIG. 11.

FIG. 11 is a sequence diagram showing a process of operating a field when each field is not classified into an attribute category. The same step numbers are used in FIG. 11 when the operation in FIG. 11 is the same as that described in FIGS. 9 and 10.

In the database 21a of FIG. 11, each field of the information to be managed is not classified into an attribute category (namely, the attribute category table 22 is not defined). In this case, in the authority definition table 23, an authority for specifying the authorization of each operation with respect to each field (hereinafter referred to as “field authority”) is defined; and in the authority set definition table 24, each authority set is defined based on a list of the field authorities.

Therefore, when transmitting a request to the access authority determining section 63 to check an authority, the database 21a designates a field name (document name) as the resource information (step S120). As a result, the access authority determining section 63 may carry out the processes in step S150 and the subsequent steps to determine whether the requested operation is permitted without being concerned about whether a value designated as the resource information is an attribute category or a field.

The process in FIG. 10 and the process in FIG. 11 are the same except that a value designated as the resource information is the attribute category and the field, the value being transmitted between the access authority determining section 63 and the database 21 and between the access authority determining section 63 and the database 21a, respectively. In any case, the access authority determining section 63 does not have to be concerned about whether the attribute category or the field is designated as a value of the resource information. This is because the access authority determining section 63 treats the attribute category or the field transmitted as the resource information as a simple character string.

Because of this feature, the application program interface (API) of the access authority determining section 63 may be unified regardless of whether a field is classified into an attribute category. Therefore, even when the database 21 and the database 21a are both provided, the access authority determining section 63 may determine whether the operation with respect to any of the databases 21 and 21a is permitted by performing the same procedure.

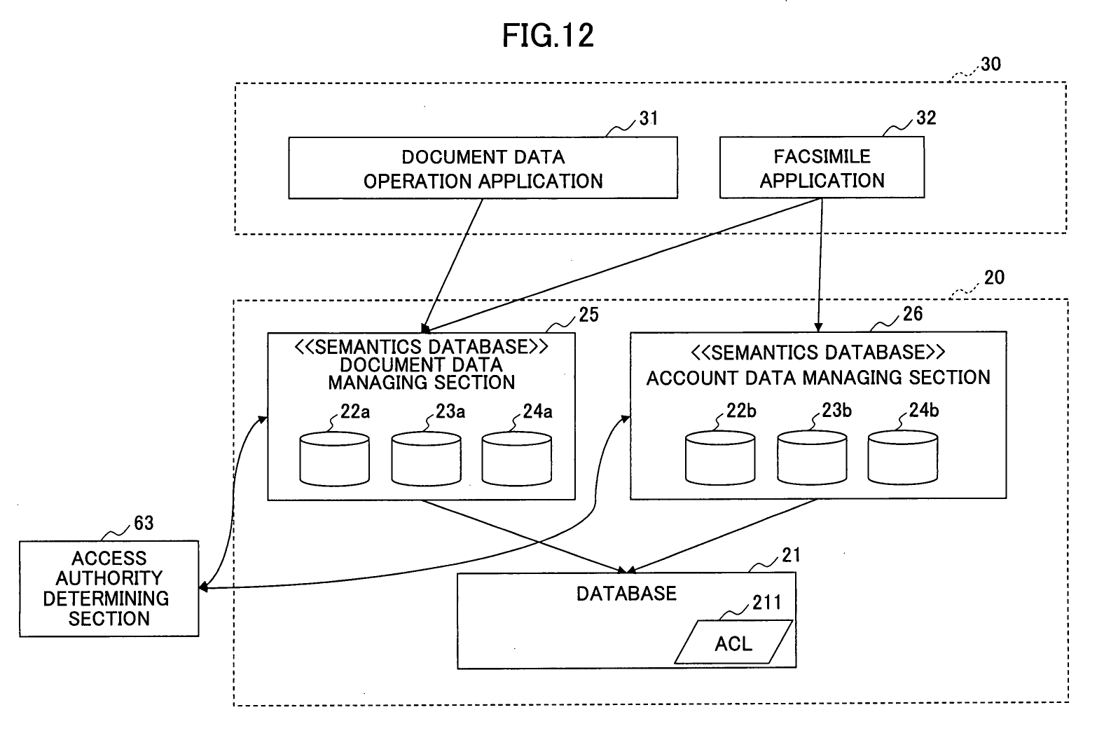

Next, a third embodiment of the present invention is described. FIG. 12 shows relationships among key software components in the third embodiment of the present invention. In FIG. 12, the same reference numerals are used for the same elements in FIG. 8, and the descriptions of the same elements are omitted.

FIG. 12 shows a case where a document data managing section 25 and an account data managing section 26 are added to the application common service 20 as software components. The document data managing section 25 includes logic to interpret the meaning (configuration) of the document data managed by the database 21. On the other hand, the account data managing section 26 include logic to interpret the meaning of the account data (account information) managed by the database 21.

Namely, in each of first and second embodiments of the present invention, logic to interpret the meaning of the data managed by the database 21 is required to be implemented in the database 21 or the application 30. In a case where the logic is implemented in the data base 21, unfortunately, whenever a new kind of data to be managed (semantics) is added, the source code of the database 21 needs to be modified. On the other hand, when the logic is implemented in the application 30, the logic is required to be implemented in each of the applications. As a result, the implementation form disadvantageously becomes redundant.

To overcome the problems, in the third embodiment of the present invention, as shown in FIG. 12, a part capable of interpreting the data managed by the database 21 (semantics database) is provided for each semantics as a software component. By doing this, it becomes unnecessary to implement basic logic into either the database 21 or the application 30, the logic interpreting the meaning of the data. Further, when the data in new semantics is added to the database 21, what is necessary is to add a semantics database corresponding to the new semantics as a plug-in, thereby enhancing the expandability corresponding to the increase of semantics to be managed.

It should be noted that each semantics database includes and manages the corresponding attribute category table 22, authority definition table 23, and authority set definition table 24. In an example of FIG. 12, the document data managing section 25 includes and manages an attribute category table 22a, an authority definition table 23a, and an authority set definition table 24a. In the same manner, the account data managing section 26 includes and manages an attribute category table 22b, an authority definition table 23b, and an authority set definition table 24b. In each of the attribute category table 22, the authority definition table 23, and the authority set definition table 24, necessary information for the corresponding semantics is required to be registered.

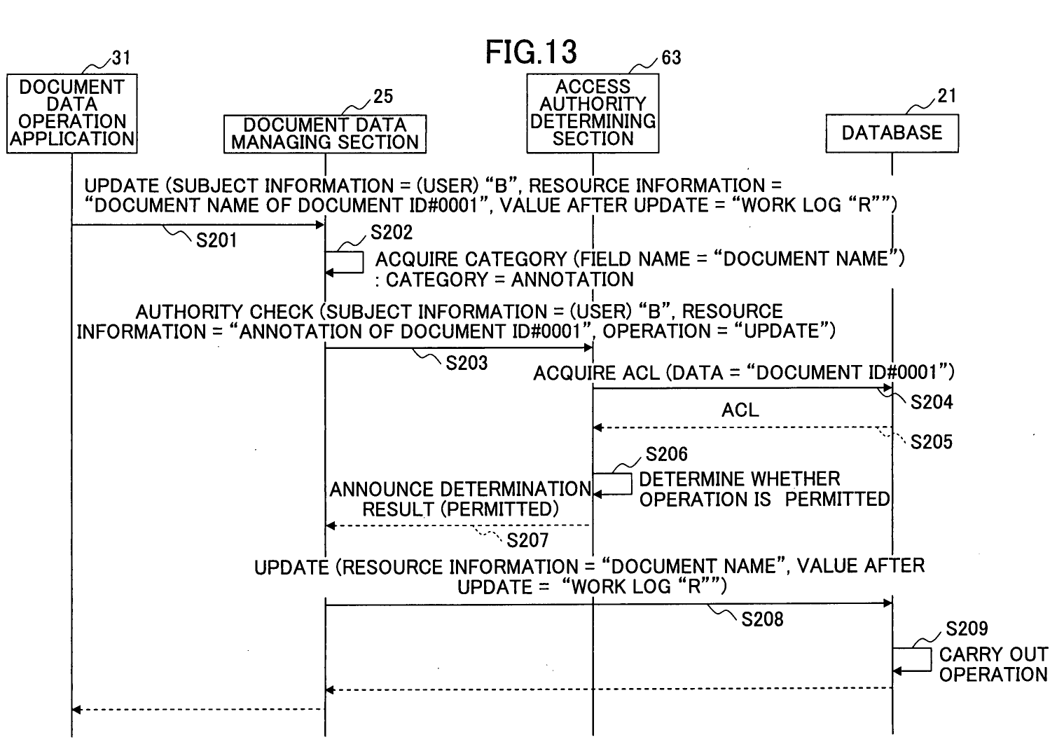

In the following, a process performed in the configuration of FIG. 12 is described. FIG. 13 is a sequence diagram showing a process of operating a field according to a third embodiment of the present invention.

For example, based on an instruction entered by a user, the document data operation application 31 transmits a request to the document data managing section 25 to operate a field of document data (step S201). In this third embodiment, the access to the database 21 is performed via a semantics database; therefore, the request to operate the field is transmitted to the document data managing section 25. It should be noted that each parameter designated in this request to operate the field may be the same as that in step S110.

Next, the document data managing section 25 converts the field name (document name) into the attribute category name (annotation (AN)) based on the attribution category table 22a (step S202). Then, the document data managing section 25 transmits a request to the access authority determining section 63 to check the authority by designating the attribute category (annotation (AN)) as the resource information (step S203).

Next, the access authority determining section 63 determines whether the requested operation is permitted in the same process as that described in steps S150 through S170 (steps S204 through 206), and transmits the determination result to the document data managing section 25 (step S207). When it is determined that the operation is permitted, the document data managing section 25 gives an instruction to the database 21 to perform the requested operation (step S208). The database 21 performs the process for realizing the requested operation based on the instruction from the document database managing section 25 (step S209).

As described above, according to the third embodiment of the present invention, the semantics database (document data managing section 25) determines whether the requested operation is to be performed based on the checking result whether the requested operation is to be performed by the access authority determining section 63. Further, the database 21 performs the requested operation based on the instruction from the semantics database without inquiring of the access authority determining section 63 about whether the requested operation is permitted. As a result, when logic for realizing the specifications of the access control specific to the semantics with respect to the data to be operated has been implemented in the semantics database, it becomes possible to add or delete the access control specific to the semantics by adding a plug-in to the semantics database or deleting a plug-in from the semantics database, respectively.

For example, a case is considered of an access control in which document data has a folder hierarchical structure, and an authority for deleting the folder is capable of deleting all documents under the folder regardless of the authority set for each of the documents. In this case, the document data managing section 25 inquires of the access authority determining section 63 about the authority of deleting the target folder. When the deletion is permitted, an instruction to delete the folder and the documents under the folder is transmitted to the database 21.

Next, a fourth embodiment of the present invention is described. In the fourth embodiment of the present invention, a concept is defined in which the field and the attribute category are abstracted (hereinafter referred to as “authority set element”), and an operating authority may be separately set for each authority set element.

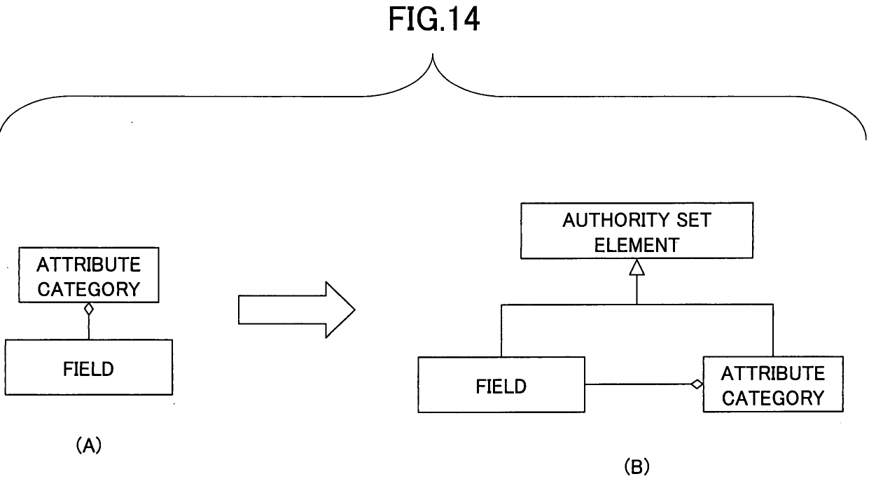

FIG. 14 shows relationships between the attribute category and the fields. The left panel (A) in FIG. 14 shows a relationship between the attribute category and the field according to the first through the third embodiments of the present invention. The relationship shown in left panel (A) of FIG. 14 shows that the attribute category aggregates the fields. On the other hand, the right panel (B) in FIG. 14 shows a relationship between the attribute category and the fields. As shown in the right panel (B) of FIG. 14, the attribute category and the fields are abstracted (generalized) by a concept of the authority set element.

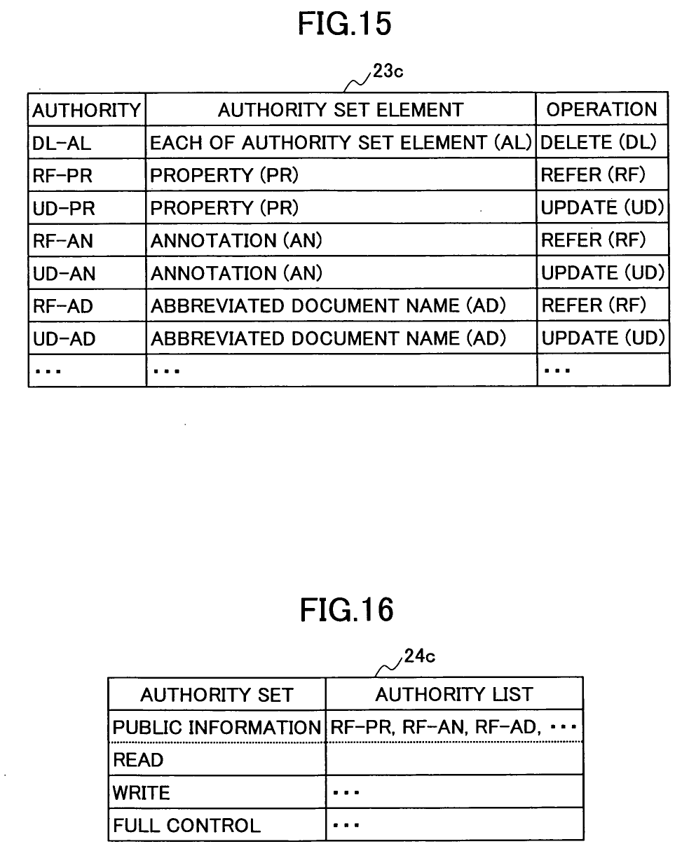

Specifically, this configuration means that the authority with respect to each operation with respect to not only the attribute category but also the field may be defined in the authority definition table 23. FIG. 15 shows an example of authority definition table 23c according to the fourth embodiment of the present invention.

As shown in FIG. 15, in the authority definition table 23c, the authority may be registered for each authority set element (attribute category and field). Therefore, an operating authority with respect to each field as well as each attribute category may be registered as the authority. In the example of FIG. 15, the term “abbreviated document (AD)” corresponds to the field. The authority permitting the “refer” and “update” operations with respect to the “abbreviated document name (AD)” field are “RF-AD”, and “UD-AD”, respectively.

In this case, the registered contents of the authority set definition table 24 are as follows. FIG. 16 shows an example of the authority set definition table 24c according to the fourth embodiment of the present invention. As shown in FIG. 16, as the “authority list” with respect to the “authority set” in the authority set definition table 24c according to the fourth embodiment of the present invention, an authority (“RF-AD”) with respect to each field may be registered.

It should be noted that the process according to the fourth embodiment of the present invention may be substantially the same as that described above. However, when the field name is to be converted into the attribute category name based on the attribute category table 22 and there is no attribute category corresponding to the field, a decision whether the requested operation is permitted may be made based on whether the authority registered in the authority definition table 23 with respect to the field is included in the ACL 211 as the authority (authority set) for a user who is the operating subject.

As described above, according to the fourth embodiment of the present invention, the operating authority may be set for each of the attribute and the field. Because of this feature, advantageously, it is not necessary to define the attribute category including only one field. As a result, the memory capacity necessary to store the information of the access authorities may be reduced.

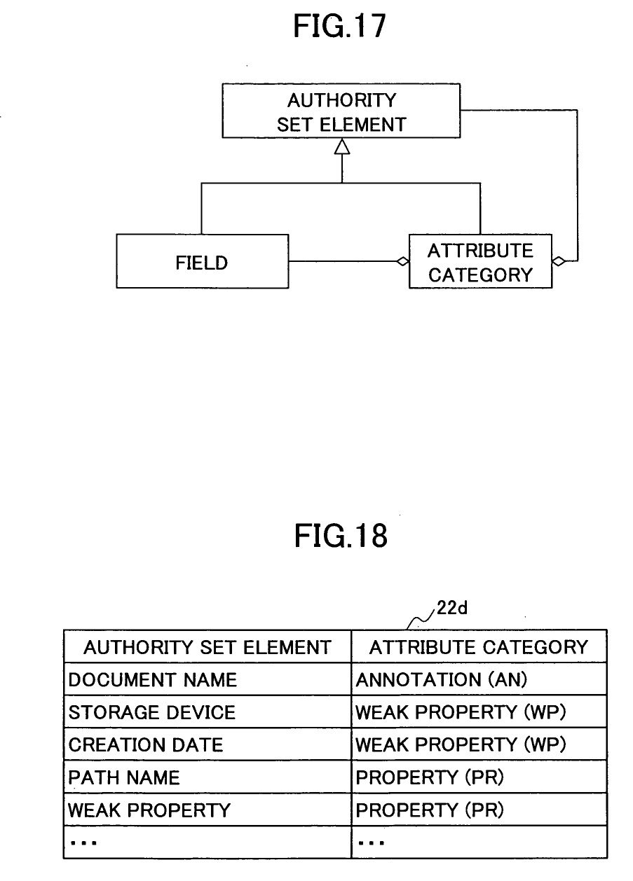

Next, a fifth embodiment of the present invention is described. FIG. 17 shows a relationship between the attribute category and the field according to the fifth embodiment of the present invention. As the relationship of FIG. 17 shows, the attribute category aggregates the authority set elements. Because of this structure, the relationship may allow a nesting structure (a recursive relationship) in which an attribute category is defined in another attribute. In the same manner, because of the structure, an attribute category including two or more attribute categories, and an attribute including one or more attribute categories and one or more fields may also be defined. It should be noted that the relationship of FIG. 17 is based on the relationship of FIG. 15. Because of this feature, what can be performed in a configuration according to the fourth embodiment of the present invention may also be performed in a configuration according to the fifth embodiment of the present invention.

In a case where the relationship between the attribute category and the field is defined as shown in FIG. 17, the attribute category may be configured as follows. FIG. 18 shows an example of the attribute category table 22d according to the fifth embodiment of the present invention.

As shown in FIG. 18, the relationships between each authority set element (field and attribute category) and the corresponding attribute category is registered in the attribute category table 22d. In FIG. 18, for example, each of a field called “storage device” and a field called “creation date” is included in an attribute category called “weak property (WP)”. Further, the “weak property (WP)” is included in an attribute category called “property”. The attribute category called “property” includes not only the “weak property (WP)” but also a field called “path name”.

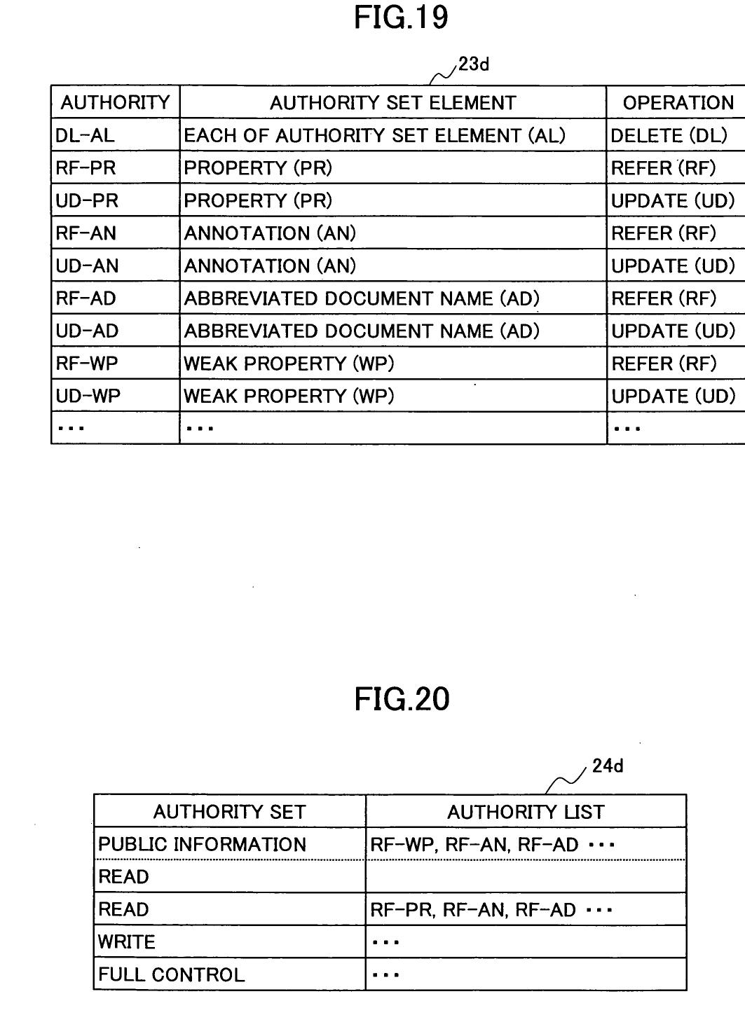

Further, FIG. 19 shows an example of an authority definition table 23d according to the fifth embodiment of the present invention. As shown in FIG. 19, in the authority definition table 23d, the authority may be registered for each authority set element (attribute category and field) in the same manner as in the fourth embodiment of the present invention. As a result, the authority (RF-WP, UD-WP) may also be registered for an attribute category included in another attribute category (included property).

Further, FIG. 20 shows an example of an authority set definition table 24d according to the fifth embodiment of the present invention. As shown in FIG. 20, in the authority set definition table 24d, the authority (RF-WP) of the attribute category included in another attribute category may be registered in the authority list with respect to the authority set.

It should be noted that the process according to the fifth embodiment of the present invention may be substantially the same as that described above. However, in the fifth embodiment, plural attribute categories with respect to the field to be operated may be recursively obtained. Further, the determination whether the requested operation is permitted may be made by checking whether the authority with respect to the each of the plural attribute categories recursively obtained is included in the authority list with respect to the authority set.

As described above, according to the fifth embodiment of the present invention, a range of the field to which the operating authority is set may be effectively set based on the included relationship obtained from the recursive relationship obtained by recursively defining the attribute category. Specifically, in FIG. 18, there is a relationship where the “weak property (WP)” is included in the “property”. When, for example, the operating authority with respect to the “weak property (WP)” is set for a user “X”, and the operating authority with respect to the “property” is set for a user “Y”, it becomes possible to effectively (easily) give authority settings having different authority ranges between the user “X” and the user “Y”.

It should be noted that, in the fifth embodiment of the present invention, when the recursive relationship of the attribute category registered in the attribute category table 22d is expanded, the recursive relationship already expanded may be stored in a memory or the attribute category table 22d. By doing this, the processing speed of searching for an attribute category including a field included in the same attribute category may be improved in the next search.

Further, the recursive relationship of the attribute category may be expanded when the multi-functional peripheral 1 is booted. Further, the attribution category table 22d may be created after the recursive relationship has been expanded.

The embodiments of the present invention are described in detail above. However, the present invention is not limited to the embodiments of the present invention, and various modifications and substitutions may be made without departing from the scope or spirit of the present invention.

What is claimed is:

1. An information processing apparatus capable of determining whether an operation with respect to information including plural items is permitted, the apparatus comprising:
a classified information managing unit managing classified information in which categorization of the items is defined;
an operation authority information managing unit managing operation authority information in which an operating authority given to an operation subject is set with respect to each of the categories;
a category determining unit determining one of the categories based on the classified information, the one of the categories including an item to be operated; and
a permit determining unit determining whether an operation is permitted based on the category determined by the category determining unit and the operation authority information.

2. The information processing apparatus according to claim 1, wherein
the operating authority with respect to each of the items and the categories is defined in the operation authority information; and
the permit determining unit determines whether the operation is permitted based on the operating authority with respect to each of the items to be operated when the operating authority with respect to each of the items is set in the operation authority information.

3. The information processing apparatus according to claim 2, wherein
the operating authority with respect to each of the items that is not included in any of the categories is defined in the operation authority information.

4. The information processing apparatus according to claim 1, wherein
the attribute category is recursively defined in the classified information.

5. The information processing apparatus according to claim 4, wherein
the recursive relationship of the attribute category is expanded and defined in the classified information.

6. An information processing method capable of determining whether an operation with respect to information including plural items is permitted, the method comprising:
a classified information managing step of managing classified information in which categorization of the items is defined;
an operation authority information managing step of managing operation authority information in which an operating authority given to an operation subject is set with respect to each of the categories;
a category determining step of determining one of the categories based on the classified information, the one of the categories including an item to be operated; and
a permit determining step of determining whether an operation is permitted based on the category determined in the category determining step and the operation authority information.

7. The information processing method according to claim 6, wherein
the operating authority with respect to each of the items and the categories is defined in the operation authority information; and
the permit determining step determines whether the operation is permitted based on the operating authority with respect to each of the items to be operated when the operating authority with respect to each of the items is set in the operation authority information.

8. The information processing method according to claim 7, wherein
the operating authority with respect to each of the items that is not included in any of the categories is defined in the operation authority information.

9. The information processing method according to claim 6, wherein
the attribute category is recursively defined in the classified information.

10. The information processing method according to claim 9, wherein
the recursive relationship of the attribute category is expanded and defined in the classified information.
